(19) United States
(12) Patent Application Publication
(10) Pub. No.: US 2009/0200274 A1
(43) Pub. Date: Aug. 13, 2009

(54) Electrode Arrangement for Electrical Discharge Machining on an Electrically Non-Conductive Material

(76) Inventors: Ralf Förster, Berlin (DE); Karsten Klein, Berlin (DE); Ulrich Laudien, Berlin (DE); Silke Settegast, Berlin (DE); Ramesh Subramanian, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/225,516

(22) PCT Filed: Feb. 16, 2007
(86) PCT No.: PCT/EP2007/051519

§ 371 Date: Mar. 9, 2009

(30) Foreign Application Priority Data
Mar. 24, 2006 (EP) 06006139.7

(51) Int. Cl. B23H 1/04; B23H 1/00

(52) U.S. Cl. 219/69.15; 219/69.17

(57) ABSTRACT

The invention relates to an electrode arrangement for the electrical discharge machining of an electrically non-conductive material, which comprises a first component for removing the electrically non-conductive material and a second component for depositing an electrically conductive substance on the electrically non-conductive material.

### CROSS REFERENCE TO RELATED APPLICATIONS

This application is the US National Stage of International Application No. PCT/EP2007/051519, filed Feb. 16, 2007 and claims the benefit thereof. The International application claims the benefits of European application No. 06006139.7 filed Mar. 24, 2006, both of the applications are incorporated by reference herein in their entirety.

### FIELD OF INVENTION

The invention relates to an electrode arrangement for electrical discharge machining on an electrically non-conductive material and to a method for electrical discharge machining on an electrically non-conductive material, using the electrode arrangement.

### BACKGROUND OF THE INVENTION

Electrical discharge machining methods for electrically non-conductive materials are known in the prior art. They are employed, inter alia, in order to make bores in components which are provided with a ceramic coating. Thus, for example in turbine blades which have a ceramic heat insulation layer on a metallic basic body, cooling air bores are made by electrical discharge.

DE 41 02 250 A1 describes in general terms a method for electrical discharge machining on electrically non-conductive materials. In this method, the non-conductive material, before being machined, is coated with an electrically conductive substance. This layer is used as an assisting electrode which makes electrical contacting with a working electrode during electrical discharge machining. The electrically non-conductive material coated with the assisting electrode and at least that end region of the working electrode which points toward the assisting electrode and at which there is electrical discharge during machining are dipped into a dielectric which is formed by a liquid, such as kerosene, or else a gas.

When a voltage is applied to the arrangement, electrical discharge occurs between the working electrode and the assisting electrode, and, consequently, an erosion of the assisting electrode and of the electrically non-conductive material lying beneath it. At the same time, part of the dielectric is cracked, thus giving rise to carbon or to conductive carbides which are deposited in the form of an electrically conductive layer onto the exposed surface regions of the non-conductive material. The electrically conductive layer deposited in this way therefore replaces the eroded material of the assisting electrode and, when the working electrode penetrates into the non-conductive material, makes a conductive connection with the surface of the non-conductive material, so that continuous machining is possible.

It is considered a disadvantage that, in the known method, the machining speed is limited, since the process of depositing the conductive layer takes place slowly. Prompt machining is therefore not possible. Moreover, because of the low thickness of the newly formed layer which is in the μm range, there may easily be interruptions in the conductions if this is damaged, thus bringing the process to a complete standstill.

### SUMMARY OF INVENTION

The object of the present invention is to provide an electrode arrangement which allows a rapid and reliable formation of the additional conductive layer of an electrically conductive substance on the electrically non-conductive material and at the same time a prompt erosion of the electrically non-conductive material.

The object is achieved, according to the invention, by means of an electrode arrangement with a first component for eroding the electrically non-conductive material and with a second component for depositing an electrically conductive substance on the electrically non-conductive material. The basic principle, therefore, is that in each case a component of the electrode arrangement is optimized for a task in each case, either erosion or deposition.

A particular advantage of the electrode arrangement according to the invention is that the formation of the additional conductive layer, which consists of the electrically conductive substance, takes place quickly and reliably. As a result, the possible machining speed rises considerably, as compared with the methods described in the prior art. Since the deposition of the electrically conductive substance takes place under optimized conditions, the additional electrically conductive layer has higher stability. This reduces the risk that damage to the layer may lead to an interruption in the electrical circuit and consequently to the standstill of the method.

In one version of the invention, the first and the second components are two chemically and/or physically different compounds. They may therefore, for example, be different metals or metal alloys. Moreover, if they consist of chemically identical substances, they may differ from one another, for example, in their surface properties. It may be advantageous here that, for example, the component for eroding the non-conductive material is particularly resistant and heat-resistant and therefore remains as far as possible undamaged during electrical discharge machining, and the component for depositing an electrically conductive substance either promotes the formation of carbon from the dielectric or itself becomes a component of the electrically conductive substance.

The electrode arrangement may also be implemented such that in each case one component is applied as a coating to parts of the other component. Thus, two spatially delimited regions within the electrode arrangement are obtained, which are in each case optimized for deposition and for erosion.

Tests have shown, moreover, that an electrode arrangement which consists of a discrete erosion electrode for eroding the electrically non-conductive material and of a discrete deposition electrode for depositing the electrically conductive substance allows a particularly rapid and reliable electrical discharge machining of the electrically non-conductive material.

In this case, two discrete electrodes are present, which may be, but do not have to be, connected to one another electrically conductively. By the two electrodes being separated spatially, there is no disturbance to the process which proceeds in each case.

In this case, too, it is possible that the erosion electrode and the deposition electrode consist of two chemically and/or physically different compounds, such as, for example, two metals or metal alloys.

Moreover, the erosion electrode and the deposition electrode may have different geometries which in each case may be selected such that they assist the deposition or the erosion function. The geometry of the erosion electrode may also be selected in terms of the desired form of electrical discharge machining.

Since the deposition of the electrically conductive substance is to take place particularly on the side walls of the electrical discharge machining region, it is beneficial if the deposition electrode surrounds the erosion electrode. To be precise, this ensures that the deposition electrode is arranged spatially near to that part of the electrically non-conductive material on which the electrically conductive substance is to be deposited.

In a further embodiment of the invention, the deposition electrode and the erosion electrode are connected firmly to one another. This may be implemented, for example, in that the deposition electrode is applied partially as a coating on the erosion electrode or the erosion electrode is applied partially as a coating on the deposition electrode. The coating may consist, for example of TiN. An electrode arrangement is thereby obtained which can be produced in a simple way and has high inherent stability.

It is also possible, however, that the erosion electrode and the deposition electrode are movable independently of one another. This can ensure that the respective movement of the electrodes can be adapted to the speed of the process which they execute. This means that both the deposition electrode can be moved in a way which is optimal for its function of depositing the electrically conductive substance and the erosion electrode can be moved such that it optimally allows the erosion of the electrically non-conductive material. For this purpose, the erosion electrode and/or the deposition electrode may execute both a translational and a rotational movement or else a combination of both forms of movement.

It may be advantageous if the electrode arrangement has a control unit which controls the movement of the electrodes, in particular, in such a way that the erosion electrode and the deposition electrode are moved toward the electrically non-conductive material with different advances. This makes it possible to allow for the fact that the erosion and deposition processes can proceed at different speeds.

A method for electrical discharge machining on an electrically non-conductive material is also provided, in which one of the electrode arrangements described above is used.

The method is suitable particularly for electrically non-conductive materials which are applied as a coating to a structural part. This coating may be, for example, a heat insulation layer which, in turn, may consist of fully or partially stabilized zirconium oxide or contain the latter. Corresponding coatings are found on many structural parts, and it is often necessary to drill through these coatings, this being possible quickly and efficiently with the aid of the method according to the invention.

Tests have shown that the method according to the invention is particularly suitable for the electrical discharge machining of structural parts which belong to a turbine. Since these are nowadays mostly provided in ceramic heat insulation layers, the method according to the invention is suitable for making cooling air bores, while, here, it is possible to form opening regions in the form of diffusers directly during the electrical discharge machining. This applies particularly to moving blades or guide blades of turbines.

### BRIEF DESCRIPTION OF THE DRAWINGS

The electrode arrangement according to the invention and the method according to the invention are explained in more detail below by means of two drawings in which:

FIG. 1 shows an electrode arrangement for electrical discharge machining on electrically non-conductive materials according to the present invention, in a diagrammatic illustration, before the commencement of machining,

FIG. 2 shows the arrangement from FIG. 1 during machining,

FIG. 3 shows a gas turbine,

FIG. 4 shows a turbine blade, and

FIG. 5 shows a combustion chamber.

### DETAILED DESCRIPTION OF INVENTION

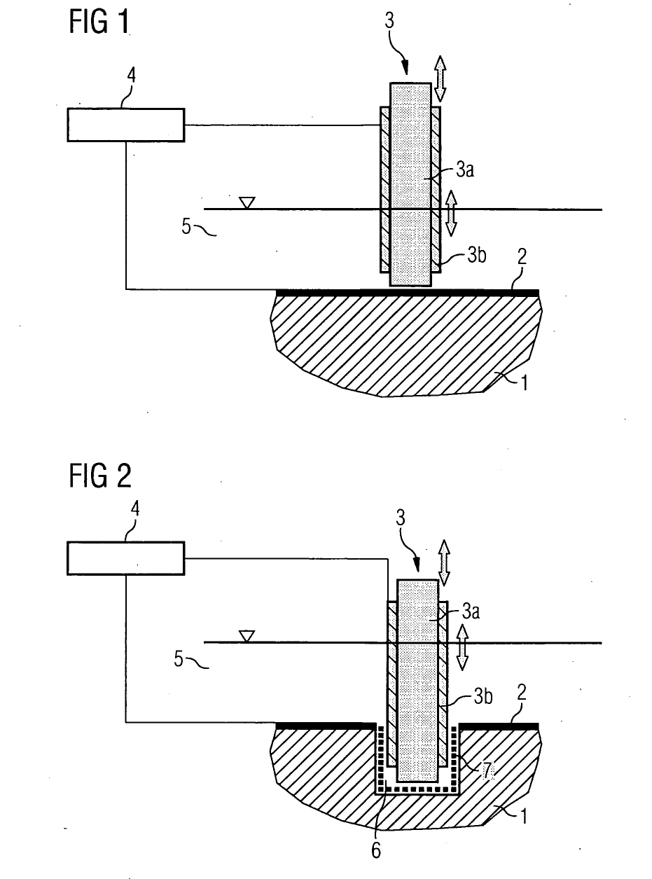

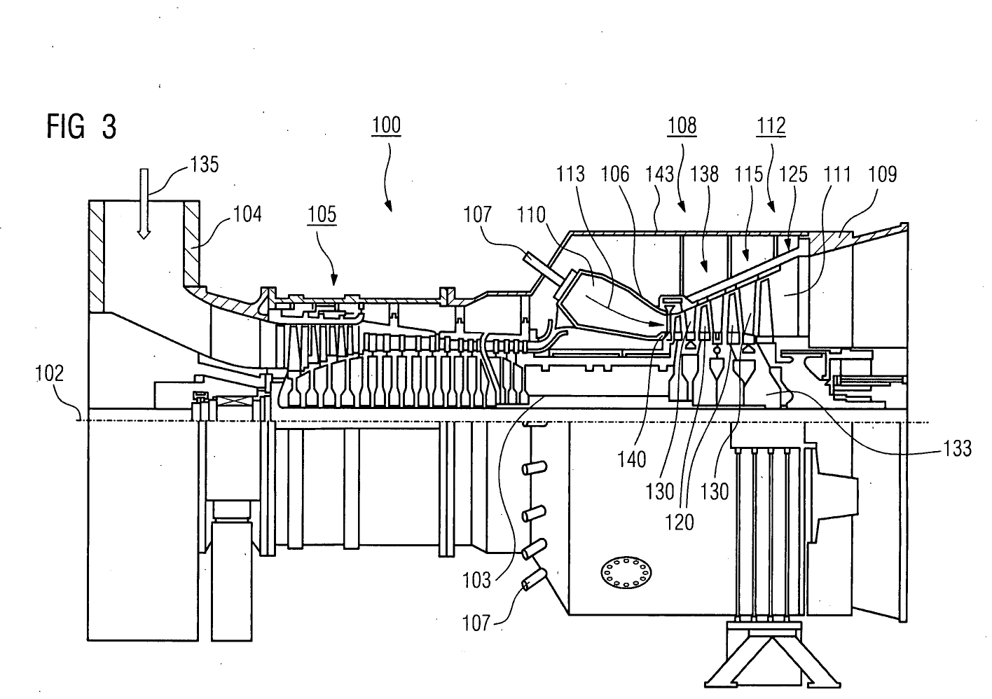

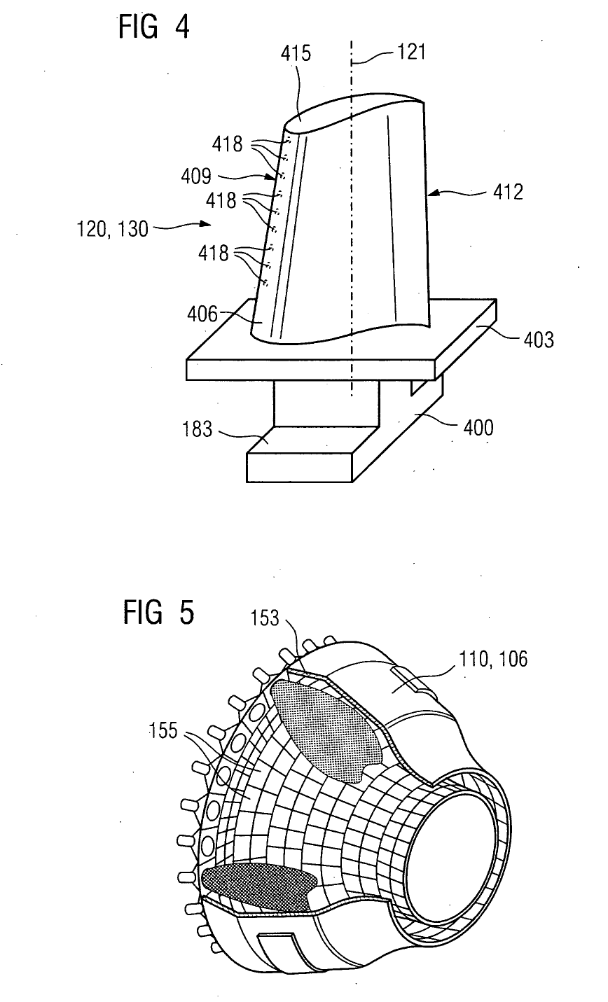

FIG. 1 shows a diagrammatic illustration of an electrode arrangement according to the invention, the electrode arrangement being illustrated before the machining of an electrically non-conductive material. In the embodiment illustrated, a structural part 1, which consists of an electrically non-conductive ceramic, is to be machined. This may be part of a turbine, such as, for example, a moving blade 120 (FIGS. 3 and 4) or a guide blade 130 (FIGS. 3 and 4). The electrically non-conductive material may also be a coating, for example in the form of a heat insulation layer, and it may consist of fully or partially stabilized zirconium oxide.

An assisting electrode 2 is applied over a large area as a layer of graphite on the surface of the structural part 1. Various methods known in the prior art are suitable for application, and it may also consist of various metals or of electrically conductive polymers. The assisting electrode 2 is connected electrically conductively to a generator 4, in the same way as an electrode arrangement 3, so that a suitable voltage is applied at both electrodes 2, 3.

In this case, the electrode arrangement 3 consists of a discrete erosion electrode 3a and of a discrete deposition electrode 3b which are connected electrically conductively to one another. Both electrodes 3a, 3b may consist of chemically and/or physically different compounds, such as, for example, two different metals. Here, moreover, they have different geometries, and the deposition electrode 3b at least partially surrounds the erosion electrode 3a. The erosion electrode 3a and the deposition electrode 3b may be connected firmly to one another, and this may be implemented, for example, in that the deposition electrode 3b is applied in the form of a coating to the side wall of the erosion electrode 3a.

On the other hand, it is also possible that the two electrodes 3a, 3b are separate structural parts and are movable independently of one another, so that they can both execute in each case a translational and/or a rotational movement. If a control unit, not shown, is additionally present in the electrode arrangement 3, the movement of the electrodes 3a, 3b can be controlled, while, in particular, it is possible that the two electrodes 3a, 3b are moved with different advances in the direction of the structural part 1.

A dielectric 5 surrounds the structural part 1, the assisting electrode 2 and the lower portion of the electrode arrangement 3. The dielectric 5 may be, for example, kerosene, but many other compounds known in the prior art are also suitable.

In order to machine the structural part 1 by electrical discharge with the aid of the method according to the invention, first an electrically conductive layer, in particular of graphite, is applied to its surface as an assisting electrode. The assisting electrode 2 and the electrode arrangement 3 are connected to the generator 4. The structural part 1 and at least the lower part of the electrode arrangement 3 at which the electrical discharge machining takes place are surrounded by the dielectric 5.

As shown in FIG. 2, the erosion electrode 3a of the electrode arrangement 3 is brought into the immediate vicinity of the assisting electrode 2. As soon as a suitable voltage is applied at the electrode arrangement 3 and the assisting electrode 2, electrical contacting in the form of a spark jump occurs between the assisting electrode 2 and the erosion electrode 3a. As a result of this spark formation, part of the assisting electrode 2 and the ceramic material of a structural part 1 are evaporated and eroded, in order to form an orifice 8. Moreover, during each electrical discharge, parts of the dielectric are cracked, thus giving rise to carbon and/or carbide compounds which are deposited on the exposed electrically non-conductive material of the structural part 1 by the deposition electrode 3b, thus forming a conductive layer 7 which replaces the eroded material of the assisting electrode 2, so that, when the method is pursued, a spark jump occurs between the deposited layer 7 and the working electrode 3 and, consequently, the layer 7, together with the ceramic material of the structural part 1, is further eroded. Since the eroded regions of the layer 7 are filled up again by the crack products, the method can be pursued continuously.

Since the erosion electrode 3a and the deposition electrode 3b are separate structural parts which can be moved axially independently of one another and, if appropriate, also rotated or pivoted, it is possible to control the erosion process by means of a corresponding control of the erosion electrode 3a and the deposition of crack products via a corresponding control of the deposition electrode 3b and, in particular, to influence the processes also by means of a suitable choice of material for the electrodes 3a, 3b.

FIG. 3 shows by way of example a gas turbine 100 in a longitudinal part section.

The gas turbine 100 has inside it a rotor 103 rotary-mounted about an axis of rotation 102 and having a shaft 101, said rotor also being designated as a turbine rotor.

Arranged in succession along the rotor 103 are an intake casing 104, a compressor 105, a, for example, toroidal combustion chamber 110, in particular annular combustion chamber, with a plurality of coaxially arranged burners 107, a turbine 108 and the exhaust gas casing 109.

The annular combustion chamber 110 communicates with a, for example, annular hot gas duct 111. There, for example, four turbine stages 112 connected in series form the turbine 108.

Each turbine stage 112 is formed, for example, from two blade rings. As seen in the direction of flow of a working medium 113, a row 125 formed from moving blades 120 follows a guide blade row 115 in the hot gas duct 111.

The guide blades 130 are in this case fastened to an inner casing 138 of a stator 143, whereas the moving blades 120 of a row 125 are attached to the rotor 103, for example by means of a turbine disk 133.

A generator or a working machine (not illustrated) is coupled to the rotor 103.

While the gas turbine 100 is in operation, air 135 is sucked in through the intake casing 104 by the compressor 105 and is compressed. The compressed air provided at the turbine-side end of the compressor 105 is routed to the burners 107 and is mixed there with a fuel. The mixture is then burnt, so as to form the working medium 113, in the combustion chamber 110. The working medium 113 flows from there along the hot gas duct 111 past the guide blades 130 and the moving blades 120. At the moving blades 120, the working medium 113 expands so as to transmit a pulse, so that the moving blades 120 drive the rotor 103 and the latter drives the working machine coupled to it.

The structural parts exposed to the hot working medium 113 are subject to thermal loads while the gas turbine 100 is in operation. The guide blades 130 and moving blades 120 of the first turbine stage 112, as seen in the direction of flow of the working medium 113, are subjected to the highest thermal load, in addition to the heat shield elements lining the annular combustion chamber 110.

In order to withstand the temperatures prevailing there, these may be cooled by means of a coolant.

Substrates of the structural parts may likewise have a directional structure, they are monocrystalline (SX structure) or have only longitudinally directed grains (DS structure).

The material used for the structural parts, in particular for the turbine blade 120, 130 and structural parts of the combustion chamber 110, is, for example, iron-, nickel- or cobalt-based superalloys.

Such superalloys are known, for example, from EP 1 204 776 B1, EP 1 306 454, EP 1 319 729 A1, WO 99/67435 or WO 00/44949; these publications are part of the disclosure in terms of the chemical composition of the alloys.

The guide blade 130 has a guide blade foot (not illustrated here) facing the inner casing 138 of the turbine 108 and a guide blade head lying opposite the guide blade foot. The guide blade head faces the rotor 103 and is secured to a fastening ring 140 of the stator 143.

FIG. 4 shows a perspective view of a moving blade 120 or guide blade 130 of a turbomachine which extends along a longitudinal axis 121.

The turbomachine may be a gas turbine of an aircraft or of a power station for electricity generation, a steam turbine or a compressor.

The blade 120, 130 has successively along the longitudinal axis 121a fastening region 400, a blade platform 403 adjacent to the latter and also a blade leaf 406 and a blade tip 415.

As a guide blade 130, the blade 130 may have (not illustrated) a further platform at its blade tip 415.

In the fastening region 400, a blade foot 183 is formed, which serves (not illustrated) for fastening the moving blades 120, 130 to a shaft or a disk.

The blade foot 183 is configured, for example, as a hammer head. Other configurations of a pinetree or dovetail foot are possible.

The blade 120, 130 has, for a medium passing through the blade leaf 406, a leading edge 409 and a trailing edge 412.

In conventional blades 120, 130, for example, solid metallic materials, in particular superalloys, are used in all the regions 400, 403, 406 of the blade 120, 130.

Such superalloys are known, for example, from EP 1 204 776 B1, EP 1 306 454, EP 1 319 729 A1, WO 99/67435 or WO 00/44949; these publications are part of the disclosure in terms of the chemical composition of the alloy.

The blade 120, 130 may in this case be manufactured by means of a casting method, also by means of directional solidification, by a forging method, by a milling method or a combination of these.

Workpieces having a monocrystalline structure or structures are used as structural parts for machines which are exposed during operation to high mechanical, thermal and/or chemical loads.

The manufacture of monocrystalline workpieces of this type takes place, for example, by directional solidification from the melt. Casting methods are involved in which the liquid metallic alloy solidifies into the monocrystalline structure, that is to say into the monocrystalline workpiece, or directionally.

In this case, dendritic crystals are oriented along the heat flow and form either a columnar-crystalline grain structure (columnar, that is to say grains which run over the entire length of the workpiece and here, according to general linguistic practice, are designated as being directionally solidified) or a monocrystalline structure, that is to say the entire workpiece consists of a single crystal. In these methods, the transition to globulitic (polycrystalline) solidification must be avoided, since, due to undirected growth, transverse and longitudinal grain boundaries are necessarily formed, which nullify the good properties of the directionally solidified or monocrystalline structural part.

If directionally solidified structures are referred to in general terms, this means both monocrystals which have no grain boundaries or at most low angle grain boundaries and columnar-crystal structures which have grain boundaries running in the longitudinal direction, but no transverse grain boundaries. In the case of the second-mentioned crystalline structures, directionally solidified structures are also referred to.

Such methods are known from U.S. Pat. No. 6,024,792 and EP 0 892 090 A1; these publications are part of the disclosure in terms of the solidification method.

The blades 120, 130 may likewise have coatings against corrosion or oxidation, for example (MCrAlX; M is at least one element of group iron (Fe), cobalt (Co), nickel (Ni), X is an active element that stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1 which are to be part of this disclosure in terms of the chemical composition of the alloy.

The density preferably lies at 95% of the theoretical density.

A protective aluminum oxide layer (TGO=thermal grown oxide layer) is formed on the MCrAlX layer (as an intermediate layer or as the outermost layer).

On the MCrAlX, a heat insulation layer may also be present, which is preferably the outermost layer and consists, for example, of ZrO₂, Y₂O₃—ZrO₂, that is to say it is not stabilized or is partially or completely stabilized by yttrium oxide and/or calcium oxide and/or magnesium oxide.

The heat insulation layer covers the entire MCrAlX layer.

Columnar grains are generated in the heat insulation layer by means of suitable coating methods, such as, for example, electron beam evaporation (EP-PVD).

Other coating methods may be envisaged, for example atmospheric plasma spraying (APS), LPPS, VPS or CVD. The heat insulation layer may have porous, microcrack or macrocrack-susceptible grains for better thermal shock resistance. The heat insulation layer is therefore preferably more porous than the MCrAlX layer.

The blade 120, 130 may be of hollow or solid design. If the blade 120, 130 is to be cooled, it is hollow and, if appropriate, also has film cooling holes 418 (indicated by dashes) which are preferably produced by means of the method according to the invention.

FIG. 5 shows a combustion chamber 110 of the gas turbine 100. The combustion chamber 110 is configured, for example, as what is known as an annular combustion chamber, in which a multiplicity of burners 107 arranged around an axis of rotation 102 in the circumferential direction issue into a common combustion chamber space 154 and generate flames 156. For this purpose, the combustion chamber 110 is configured in its entirety as an annular structure which is positioned around the axis of rotation 102.

To achieve a comparatively high efficiency, the combustion chamber 110 is designed for a comparatively high temperature of the working medium M of about 1000° C. to 1600° C. In order to make it possible to have a comparatively long operating time even under these operating parameters which are unfavorable for the materials, the combustion chamber wall 153 is provided on its side facing the working medium M with an inner lining formed from heat shield elements 155.

On account of the high temperatures inside the combustion chamber 110, moreover, a cooling system may be provided for the heat shield elements 155 or for their holding elements. The heat shield elements 155 are then, for example, hollow and, if appropriate, also have cooling holes (not illustrated) which issue into the combustion chamber space 154 and which are preferably produced by means of the method according to the invention.

Each heat shield element 155 consisting of an alloy is equipped on the working medium side with an especially heat-resistant protective layer (MCrAlX layer and/or ceramic coating) or is manufactured from material resistant to high temperature (solid ceramic bricks).

These protective layers may be similar to those of the turbine blades, that is to say, for example MCrAlX means; M is at least one element of the group iron (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP-1 306 454 A1 which are to be part of this disclosure in terms of the chemical composition of the alloy.

On the MCrAlX, a, for example, ceramic heat insulation layer may also be present and consists, for example, of ZrO₂, Y₂O₃—ZrO₂, that is to say it is not stabilized or is partially or completely stabilized by yttrium oxide and/or calcium oxide and/or magnesium oxide.

Columnar grains are generated in the heat insulation layer by means of suitable coating methods, such as, for example, electron beam evaporation (EB-PVD).

Other coating methods may be envisaged, for example atmospheric plasma spraying (APS), LPPS, VPS or CVD. The heat insulation layer may have porous, micro- or macro-susceptible grains for better thermal shock resistance.

Refurbishment means that turbine blades 120, 130 and heat shield elements 155, after being used, must, where appropriate, be freed of protective layers (for example, by sandblasting). A removal of the corrosion and/or oxidation layers or products then takes place. If appropriate, cracks in the turbine blade 120, 130 or in the heat shield element 155 are also repaired. This is followed by a recoating of the turbine blades 120, 130 and heat shield elements 155 and by a renewed use of the turbine blades 120, 130 or heat shield elements 155.

Here, too, the method according to the invention may be used for reopening holes.

1.-20. (canceled)

21. An electrode arrangement for electrical discharge machining on an electrically non-conductive material, comprising:
a first component for eroding the electrically non-conductive material; and
a second component for depositing an electrically conductive substance on the electrically non-conductive material, the second component arranged on the first component.

22. The electrode arrangement as claimed in claim 21, wherein the first and the second components are two chemically and/or physically different compounds.

23. The electrode arrangement as claimed in claim 21, wherein the first and the second components are two different metals.

24. The electrode arrangement as claimed in claim 23, wherein the first component is applied partially as a coating to the second component or the second component is applied partially as a coating to the first component.

25. An electrode arrangement for electrical discharge machining on an electrically non-conductive material, comprising:
an erosion electrode for eroding the electrically non-conductive material; and
a deposition electrode for depositing an electrically conductive substance on the electrically non-conductive material.

26. The electrode arrangement as claimed in claim 25, wherein the erosion electrode and the deposition electrode consist of two chemically and/or physically different compounds.

27. The electrode arrangement as claimed in claim 25, wherein the erosion electrode and the deposition electrode consist of two different metals.

28. The electrode arrangement as claimed in claim 27, wherein the erosion electrode and the deposition electrode have different geometries.

29. The electrode arrangement as claimed in claim 28, wherein the deposition electrode surrounds the erosion electrode.

30. The electrode arrangement as claimed in claim 29, wherein the erosion electrode and the deposition electrode are connected firmly to one another.

31. The electrode arrangement as claimed in claim 30, wherein the deposition electrode is applied as a coating to the erosion electrode or the erosion electrode is applied as a coating to the deposition electrode.

32. The electrode arrangement as claimed in claim 29, wherein the erosion electrode and the deposition electrode are independently movable relative to one another.

33. The electrode arrangement as claimed in claim 32, wherein the erosion electrode and/or the deposition electrode execute a translational and/or a rotational movement.

34. The electrode arrangement as claimed in claim 33, further comprising a control unit that controls movements of the electrodes such that the erosion electrode and the deposition electrode are moved with different advances.

35. A method for electrical discharge machining on an electrically non-conductive material, comprising:
providing an erosion electrode that erodes the electrically non-conductive material; and
providing a deposition electrode that deposits an electrically conductive substance on the electrically non-conductive material.

36. The method as claimed in claim 35, wherein the electrically non-conductive material is a coating on a structural part.

37. The method as claimed in claim 36, wherein the coating is a heat insulation layer.

38. The method as claimed in claim 37, wherein the heat insulation layer contains fully or partially stabilized zirconium oxide or consists of this.

39. The method as claimed in claim 38, wherein the structural part is part of a turbine.

40. The method as claimed in claim 39, wherein the structural part is a moving or guide blade.
